(19) United States
(12) Patent Application Publication
(10) Pub. No.: US 2019/0028448 A1
(43) Pub. Date: Jan. 24, 2019

(54) METHOD TO ESTABLISH AND UPDATE KEYS FOR SECURE IN-VEHICLE NETWORK COMMUNICATION

(71) Applicant: Continental Automotive Systems, Inc,, Auburn Hills, MI (US)

(72) Inventor: Brian Farrell, Troy, MI (US)

(21) Appl. No.: 16/078,770

(22) PCT Filed: Feb. 22, 2017
(86) PCT No.: PCT/US2017/018981

§ 371 Date: Aug. 22, 2018

Related U.S. Application Data
(60) Provisional application No. 62/298,283, filed on Feb. 22, 2016.

(51) Int. Cl. H04L 29/06; H04L 9/08; H04L 9/32; H04L 29/08; H04W 4/48

(52) U.S. Cl. CPC H04L 63/062; H04L 63/0435; H04L 63/0823; H04L 9/0825; H04L 2209/84; H04L 9/3271; H04L 67/12; H04W 4/48; H04L 9/0822

(57) ABSTRACT

Procedures and a system for the ECUs within the vehicle to securely create and exchange session keys for further secure communication are disclosed. The procedures and system eliminate the need for securely tracking and storing all secret keys used on all vehicles. The procedures and system utilize public key cryptography to establish and maintain at least one session key and a set of shared secrets and challenges to facilitate use of private key cryptography within vehicle networks.

### TECHNICAL FIELD

This disclosure generally relates automotive security, and more particularly to tire inflation pressure detection and monitoring systems.

### BRIEF DESCRIPTION OF THE DRAWINGS

For a more complete understanding of the disclosure, reference should be made to the following detailed description and accompanying drawings wherein:

FIG. 1 depicts an exemplary system for securely creating, maintaining and exchanging session keys.

FIG. 2 depicts an exemplary initial exchange of secret data and session key setup.

FIG. 3 depicts an exemplary exchange of secret data and session key setup when an ECU other than a Master ECU is replaced.

FIG. 4 depicts an exemplary and session key update.

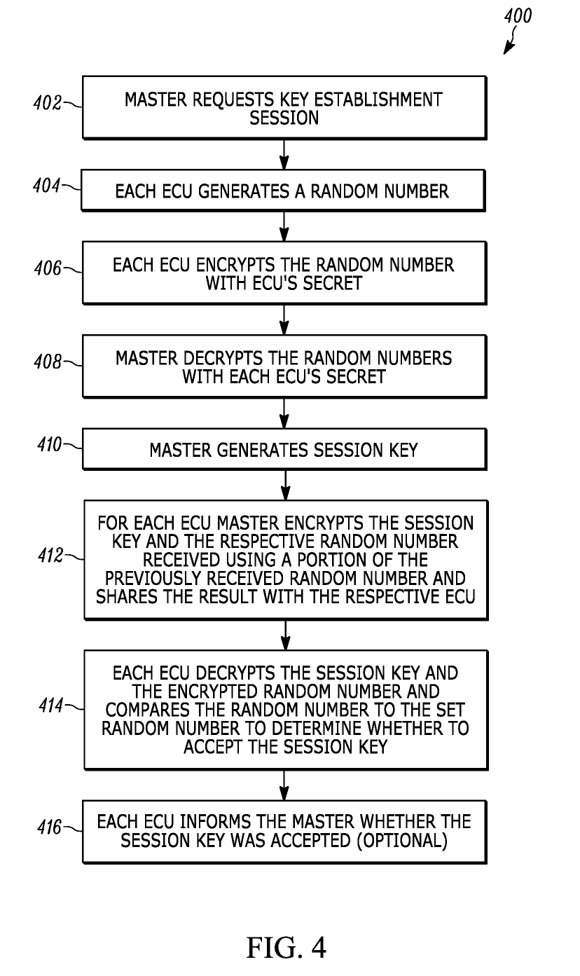

FIG. 5 depicts an exemplary state of various ECU in the system after the session key exchange.

Skilled artisans will appreciate that elements in the figures are illustrated for simplicity and clarity and have not necessarily been drawn to scale. For example, the size dimensions and/or relative positioning of some of the elements in the figures may be exaggerated relative to other elements to help to improve understanding of various aspects of the present disclosure. Also, common but well-understood elements that are useful or necessary in a commercially feasible embodiment are often not depicted in order to facilitate a less obstructed view of these various aspects of the present disclosure. Furthermore, it will be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Communication between electronic control units (ECUs) within a vehicle needs to be secure when private or safety critical data is exchanged. This ensures that private data isn't stolen and that safety critical messages aren't spoofed. Symmetric cryptography (e.g., AES) is an efficient means to encrypt data and verify that a message is authentic. In order to perform symmetric cryptography the sender and receiver of a message must have the same secret key. An efficient method of securely distributing secret keys to the ECUs that need to communicate securely is disclosed.

One method of distributing keys for secure inter-ECU communication used in vehicles requires all symmetric keys to be securely stored in a database. If this database is corrupted or lost the process to replace any ECU in the vehicle that participates in secure communication would be a very lengthy and difficult. Moreover, the database is also at risk of exposure to an attacker. In addition, in this approach, the same keys need to be used for the entire life of the vehicle, which means that when an attacker obtains a key the duration of his unauthorized access may be essentially unlimited.

Other methods of key exchange may involve requiring each ECU to have a public/private key pair, which may require additional certificates being issued by the certificate authority (CA) and additional hardware in the ECU to securely store the private key and perform processor and memory intensive key exchange algorithm, for example a Diffie-Hellman Key Exchange. These and yet other similar methods may also fail to conceal secret data from the tool or tool operator when a key exchange takes place.

Accordingly, procedures and a system for the ECUs within the vehicle to securely create, maintain, and exchange session keys for further secure communication are disclosed, eliminating the need for securely tracking and storing all secret keys used on all vehicles. Potential benefits and aspects of these procedures and system are disclosed below.

In an aspect, the session keys are only known by the ECUs and never transmitted unencrypted on the vehicle bus. The diagnostic tool, and therefore the tool operator, never knows the session keys or any of the secret data used to establish them.

In an aspect, there may be no need to securely store and maintain the ECU secret keys used for secure in-vehicle network communication in a database.

In an aspect, only one ECU, for example a gateway, may store a certified public/private key pair, for example as a certificate. To aid understanding of this disclosure this ECU will be referred to as the Master throughout this document.

In an aspect, unique data, for example a vehicle identification number (VIN) or a certificate number, within the certificate of the Master limits its use to the vehicle within which the certificate is installed. Accordingly, in an example, a stolen or fraudulent Master will be rejected by at least some, and preferably all, other ECUs in the vehicle, because the Master will not have a certificate recognized as valid to initiate communication or because the Master will not have the appropriate secret data (the random numbers) that was shared at the initial session key establishment.

In an aspect, stolen or fraudulent ECUs other than the Master will be rejected by all other ECUs since they will not have the current session key or the initial secret random number that is used to encrypt new session keys.

In an aspect, session keys can be easily and quickly updated during the life of the vehicle.

In an aspect, if an attacker obtains any of the secrets held within the ECUs of a vehicle he can perform an only attack on that particular vehicle. Alternatively, the attacker can perform an attack only on a subset of vehicles.

In an embodiment, an ECU acting as the Master is provided with the following information prior to the key exchange:
1. A public-private key pair and a certificate, hereafter referred to as the Master certificate, signed by a CA comprising a Master public key and some other piece of unique information that makes the certificate valid, preferably only, for this vehicle. In an aspect the CA may be an automotive OEM or a tier-1 or tier-2 supplier. In an aspect, the piece of unique information may be a VIN or a certificate number. The validity of the certificate is limited so that if the Master private key is obtained from the ECU, the Master private key cannot be used effectively on at least some other vehicles, and preferably on all other vehicles.
2. A diagnostic public key is used to authenticate the validity of a diagnostic tool or Server. The diagnostic tool may act as an interface between the Master and the Server, or the Master may communicate with the Server directly or through another intermediary, such as, for example another ECU in the vehicle. In an example the intermediary may be a telematics control unit (TCU).

In an embodiment, each ECU, other than the Master, that participates in secure communication on the in-vehicle network is provided with the following information prior to the key exchange.
1. The unique information found in the certificate of the Master.
2. The CA public key corresponding to the private key that was used to sign the Master certificate.

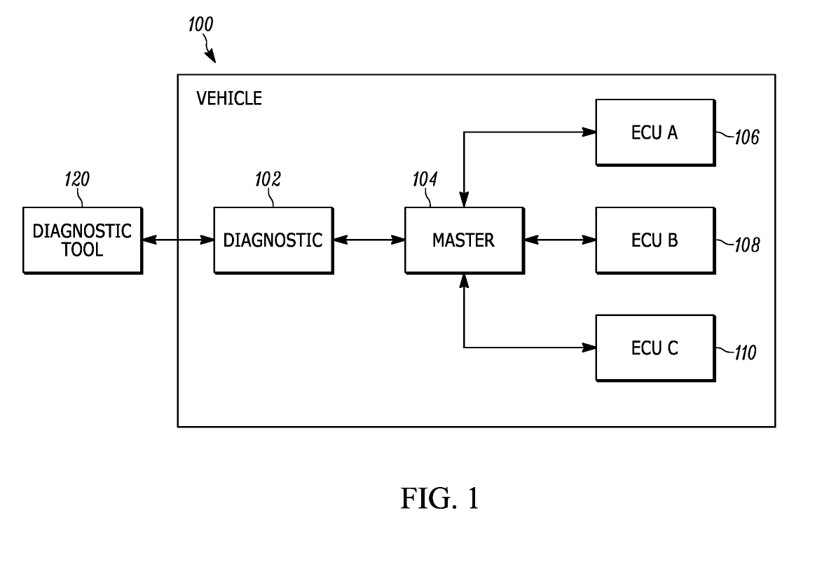

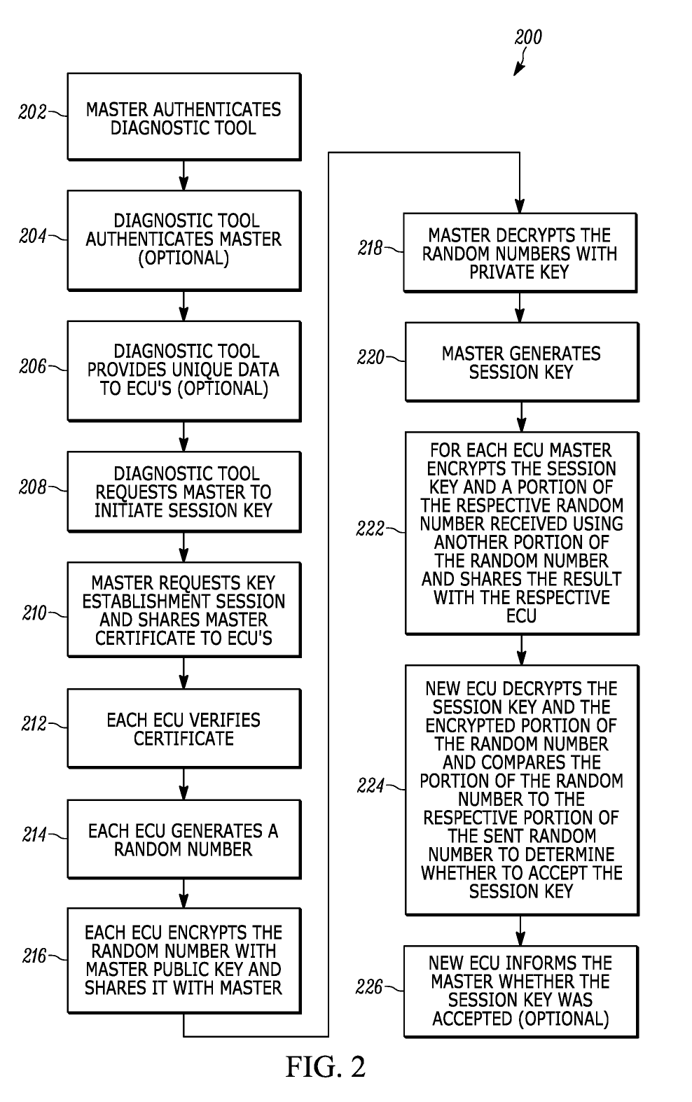

With reference to FIG. 1 and FIG. 2, in an embodiment, an initial exchange of secret data and session key setup 200 would occur prior to the delivery of the vehicle to the end user, preferably at vehicle 100 manufacturing. In a non-limiting example, the initial exchange of secret data and session key setup may be performed using a diagnostic tool 120 communicatively coupled to the Master 104 via a diagnostic port 102, such as, for example, an OBD II port. The procedure may be performed as follows:
1. The Master 104 authenticates that a diagnostic tool 120 is valid and allowed to request secured operations. Shown at 202.
2. The diagnostic tool 120 optionally authenticates the Master 104 if the Master 104 already has its certified public/private key pair. If the Master 104 was not yet provided its certified public/private key pair, the diagnostic tool 120 preferably communicates with the Server of the CA to create a certificate and preferably a public/private Master key pair and provides them to the Master 104. Shown at 204.
3. The diagnostic tool 120 preferably provides the unique data to each ECU 106, 108, 110, preferably only if the diagnostic tool 120 was authenticated to perform such an operation. Shown at 206.
4. The diagnostic tool 120 requests the Master 104 to initiate a session key establishment sequence. Shown at 208.
5. The Master 104 requests a key establishment session and shares its certificate on the in-vehicle network with at least some and preferably all ECUs 106, 108, 110, that may need to communicate securely. Shown at 210.
6. Each of the participating ECUs 106, 108, 110, verifies that the certificate is valid using the CA public key that it was provided and verifying the identity of the unique data. Shown at 212.
7. Each of the participating ECUs 106, 108, 110, generates its own random number. Shown at 214. The random number preferably comprises a portion configured to be used to verify that the Master 104 has the private key (ECU X Challenge) and a portion configured to be used to encrypt the session key (ECU X Secret). The ECU X Secret portion of the random number is preferably stored securely by each ECU X 106, 108, 110. X is used herein to identify a particular ECU 106, 108, 110, at a time.
8. Each of the participating ECUs 106, 108, 110, uses the Master public key to encrypt its random number (ECU X Challenge+ECU X Secret) using asymmetric cryptography, in an non-limiting example using RSA or ECC, so that only the Master 104 can decrypt each random number. Each of the participating ECUs 106, 108, 110, sends its encrypted random number to the Master 104. Shown at 216.
10. The Master 104 uses its private key to decrypt each random number that it receives from each ECU 106, 108, 110, obtaining an ECU X Challenge and an ECU X Secret for each ECU 106, 108, 110,. Shown at 218.
11. The Master generates a random number (Session Key1) to share between at least some, but preferably all of the participating ECUs 106, 108, 110,. Shown at 220. For each such participating ECU 106, 108, 110, the Master encrypts the session key and the received ECU X Challenge with the ECU X Secret using symmetric cryptography, in a non-limiting example using AES, and sends it to the respective ECU 106, 108, 110,. Shown at 222. In an embodiment, several different session keys could be generated and sent to the ECUs 106, 108, 110. For example, a particular message set may use a particular session key or a subset of the ECUs 106, 108, 110, may share a session key.
12. Each participating ECU 106, 108, 110, decrypts the data from the Master 104 and securely stores the session key only if the value of the returned ECU X Challenge matches the sent value. Shown at 224. Each participating ECU 106, 108, 110, preferably informs the Master 104 if the key is accepted, preferably in a way that allows the Master 104 to verify that the key has truly been received, in a non-limiting example by attaching a message authentication code (MAC) to the message that was created using the session key. Shown at 226. At this time, preferably every participating ECU 106, 108, 110, has at least one session key shared with at least some of the other participating ECUs 106, 108, 110, to securely communicate with other ECUs 106, 108, 110, and no private data was ever transmitted in the clear on the network. More preferably, all of the participating ECUs 106, 108, 110, have the same session key.

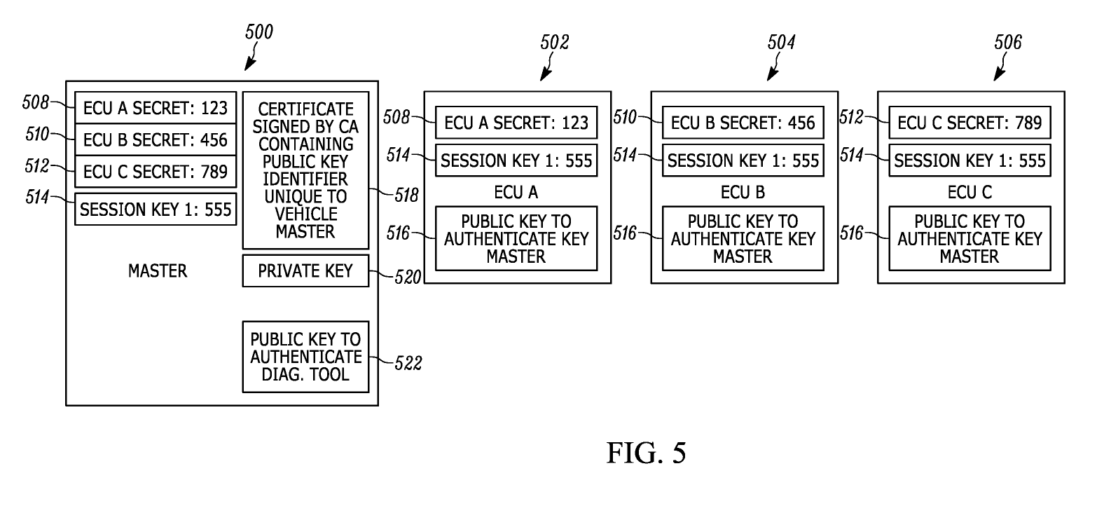

With reference to FIG. 5, in a non-limiting example, if ECU A 502 generated 123 as the ECU X Secret 508 portion of its random number in step 7, and ECU B generated 456 as the ECU X Secret 510, and ECU C generated 789 as the ECU X Secret 512 and the Key Master chose 555 as the session key 514 then the ECUs would have the information illustrated by FIG. 5 after the session key exchange.

In an embodiment, if the Master 104 is replaced then a similar or the same procedure as described with reference to an initial exchange of secret data and session key setup may be executed.

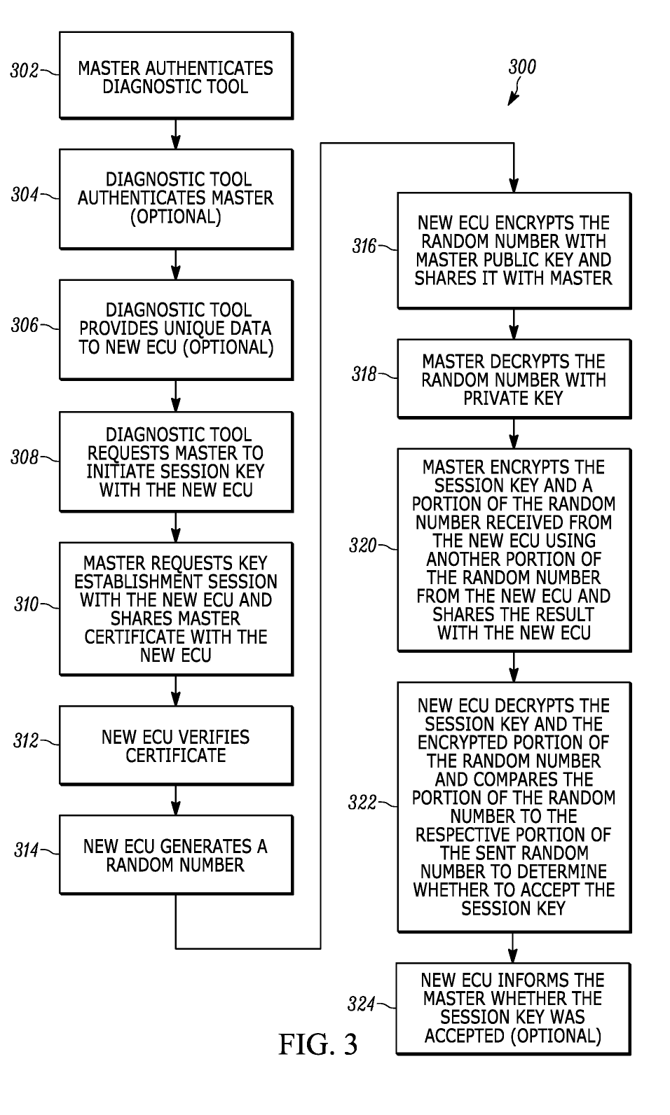

With Reference to FIG. 1 and FIG. 3, in an embodiment, if an ECU 106, 108, 110, other than the Master 104 is replaced the following procedure 300 may preferably be executed:
1. The Master 104 authenticates that the diagnostic tool is valid and allowed to request secured operations. Shown at 302.
2. The diagnostic tool 120 optionally authenticates the Master 104. Shown at 304.
3. The diagnostic tool 120 optionally writes the unique data to the new ECU 106, 108, 110, if the diagnostic tool 120 was been authenticated to perform such an operation. Shown at 306.
4. The diagnostic tool 120 requests the Master 104 to initiate a session key establishment sequence with the new ECU 106, 108, 110. Shown at 308.
5. The Master 104 requests a key establishment session and shares its certificate on the in-vehicle network with the new ECU 106, 108, 110. Shown at 310.
6. The new ECU 106, 108, 110, verifies that the certificate is valid using the CA public key that it was provided and verifying the identity of the unique data. Shown at 312.
7. The new ECU 106, 108, 110, generates a random number. The random number preferably comprises an ECU X Challenge and an ECU X Secret.
8. The ECU X Secret portion of the random number is preferably stored securely by the new ECU 106, 108, 110. Shown at 314.
9. The new ECU 106, 108, 110, uses the public key of the Master 104 to encrypt its random number (ECU X Challenge+ECU X Secret) using asymmetric, in an non-limiting example RSA, ECC, so that only the Master 104 can decrypt each random number. The new ECU 106, 108, 110, sends its encrypted random number to the Master 104. Shown at 316.
10. The Master 104 uses its private key to decrypt the random number that it receives from the new ECU 106, 108, 110, obtaining ECU X Challenge and ECU X Secret for the new ECU 106, 108, 110. Shown at 318.
11. The Master 104 encrypts the current session key(s), as applicable with reference to the initial exchange, and the received ECU X Challenge with the ECU X Secret using symmetric cryptography, in a non-limiting example AES, and sends it to the new ECU 106, 108, 110. Shown at 320.
12. The new ECU 106, 108, 110, decrypts the data from the Master 104 and securely stores the session key preferably only if the value of the returned Challenge matches the sent value. Shown at 322. The new ECU 106, 108, 110, preferably informs the Master 104 if the key is accepted, preferably in a way that allows the Master 104 to verify that the key has truly been received, in a non-limiting example by attaching a MAC to the message that was created using the session key. Shown at 324. At this time preferably every participating ECU 106, 108, 110, again has at least one session key shared with at least some of the other participating ECUs 106, 108, 110, to securely communicate with other ECUs 106, 108, 110, and no private data was ever transmitted in the clear on the network. More preferably, all of the participating ECUs 106, 108, 110, have the same session key.

In an embodiment, the session keys are periodically updated to limit the amount of time an attacker can use a session key in the case that it is obtained. If it is determined that the session key should only be allowed for a certain period of time or a certain amount of communication then a new session key may be established by following the initial exchange steps 5-12. However, in this case, the Master 104 rather than the diagnostic tool 120 would initiate the process.

In an alternative embodiment, the following procedure 400 may be used to significantly reduce the amount of time required by preferably using only symmetric cryptography, which often consumes much less computation effort than asymmetric cryptography.
1. The Master 104 requests a key establishment session. Shown at 402. The message is securely sent to each participating ECU by creating and attaching a MAC to the request using the session key.
2. Each participating ECU 106, 108, 110, generates its own random number. The random number will be used to verify that the key master has the ECU X Secret. Shown at 404.
3. Each participating ECU 106, 108, 110, uses its ECU X Secret to encrypt their random number using symmetric cryptography, in a non-limiting example using AES, so that preferably only an entity having the ECU X Secret can decrypt each random number. Each participating ECU 106, 108, 110, sends its encrypted random number to the Master 104. Shown at 406.
4. The Master 104 uses each ECU X Secret to decrypt each random number that it receives from each participating ECU 106, 108, 110, obtaining the random number for each ECU. Shown at 408.
5. The Master 104 generates a random number (Session KeyX) to share between at least some, but preferably all, of the participating ECUs 106, 108, 110. Shown at 410. For each such participating ECU 106, 108, 110, the Master 104 encrypts the session key and the received ECU X random number with the ECU X Secret using symmetric cryptography, in a non-limiting example AES, and sends it to the respective ECU 106, 108, 110. Shown at 412. In an embodiment, several different session keys could be generated and sent to the ECUs 106, 108, 110. For example, a particular message set may use a particular session key or a subset of ECUs 106, 108, 110, may share a session key.
6. Each participating ECU 106, 108, 110, decrypts the data from the Master 104 and securely stores the session key only if the value of the returned random number matches the sent value. Shown at 414. Each participating ECU 106, 108, 110, preferably informs the Master 104 if the key is accepted, preferably in a way that allows the Master 104 to verify that the key has truly been received, in a non-limiting example by attaching a MAC to the message that was created using the session key. Shown at 416. At this time preferably every participating ECU 106, 108, 110, has at least one session key shared with at least some of the other participating ECUs 106, 108, 110, to securely communicate with other ECUs 106, 108, 110, and no private data was ever transmitted in the clear on the network. More preferably, all of the participating ECUs 106, 108, 110, have the same session key.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of establishing a secure vehicle electronic control unit infrastructure, the method comprising the steps of:
initiating communication between a master, the master comprising storage configured to store a private key and a public key, the public and private keys corresponding to each other, and a certificate digitally signed by a certificate authority, the certificate comprising the public key and an identifier uniquely identifying a vehicle, and a diagnostic tool, the communication comprising:
at the master, authenticating the diagnostic tool,
at the diagnostic tool, optionally authenticating the master,
at the diagnostic tool, communicating the identifier uniquely identifying the vehicle to the master if the master has not yet been authenticated;
in response to the diagnostic tool requesting the master to initiate a session key establishment session with an electronic control unit, the initiating comprising the steps of:
at the master requesting a key establishment session with the electronic control unit and communicating a master's certificate to the electronic control unit,
at the electronic control unit, verifying that the master's certificate is valid using a certificate authority public key and checking the identifier uniquely identifying a vehicle,
at the electronic control unit, generating a random number, the random number comprising a portion configured to verify that the master has the private key corresponding to the public key and a portion configured to be used to encrypt a session key,
at the electronic control unit, storing the portion configured to verify that the master has the private key corresponding to the public key and the portion configured to be used to encrypt a session key,
at the electronic control unit, encrypting the random number with the master's public key and communicating the encrypted random number to the master,
at the master, decrypting the encrypted random number with the master's private key and identifying the portion configured to verify that the master has the private key corresponding to the public key and the portion configured to be used to encrypt the session key,
at the master, encrypting with the portion configured to be used to encrypt the session key using symmetric cryptography, a session key and the received portion configured to verify that the master has the private key corresponding to the public key and communicating the encryption results to the electronic control unit,
at the electronic control unit, decrypting the encryption results and securely storing the session key only if the returned portion configured to verify that the master has the private key corresponding to the public key matches the stored portion configured to verify that the master has the private key corresponding to the public key;
at the electronic control unit, communicating to the master if the session key was accepted.

2. A method of updating a session key in a secure vehicle electronic control unit infrastructure, the method comprising the steps of:
at a master, the master comprising storage configured to store a private key and a public key, the public and private keys corresponding to each other, and a certificate digitally signed by a certificate authority, the certificate comprising the public key and an identifier uniquely identifying a vehicle, requesting a key establishment session with an electronic control unit and communicating a master's certificate to the electronic control unit, at the electronic control unit, verifying that the master's certificate is valid using a certificate authority public key and checking the identifier uniquely identifying a vehicle,
at the electronic control unit, generating a random number, the random number comprising a portion configured to verify that the master has the private key corresponding to the public key and a portion configured to be used to encrypt a session key,
at the electronic control unit, storing portion configured to verify that the master has the private key corresponding to the public key and the portion configured to be used to encrypt a session key,
at the electronic control unit, encrypting the random number with the master's public key and communicating the encrypted random number to the master,
at the master, decrypting the encrypted random number with the master's private key and identifying the portion configured to verify that the master has the private key corresponding to the public key and the portion configured to be used to encrypt the session key,
at the master, encrypting with the portion configured to be used to encrypt the session key using symmetric cryptography, a session key and the received portion configured to verify that the master has the private key corresponding to the public key and communicating the encryption results to the electronic control unit,
at the electronic control unit, decrypting the encryption results and securely storing the session key only if the returned portion configured to verify that the master has the private key corresponding to the public key matches the stored portion configured to verify that the master has the private key corresponding to the public key;
at the electronic control unit, communicating to the master if the session key was accepted.

3. A method of updating a session key in a secure vehicle electronic control unit infrastructure, the method comprising the steps of:
at a master, the master configured to store a session key, requesting a key establishment session with an electronic control unit comprising securely communicating a message and message authentication code in the request, the secure communicating being conducted using a current session key;
at the electronic control unit, generating a random number, the random number being configured to verify that the master is in possession of an electronic control unit secret, the electronic control unit secret being configured to encrypt the electronic control unit random number using symmetric cryptography in a manner that only one in possession of the electronic control unit secret is able to decrypt the electronic control unit random number;
at the master, decrypting the encrypted electronic control unit random number to arrive at the decrypted electronic control unit random number;
at the master, generating a master random number configured to be a new session key, encrypting with the electronic control unit secret using symmetric cryptography the new session key and the decrypted electronic control unit random number and sending the encryption result to the electronic control unit
wherein the electronic control unit decrypts the data from the master and securely stores the new session key only if the value of the returned random number matches the sent value.

4. The method as recited in claim 3 wherein a plurality of different session keys is generated and sent to a plurality of electronic control units.

5. The method as recited in claim 4 wherein a particular message set uses a particular session key.

6. The method as recited in claim 4 wherein a set of electronic control units share a session key.

7. (canceled)

8. The method as recited in claim 3 wherein the electronic control unit informs the master if the key was accepted.

9. The method as recited in claim 8 wherein the information from the electronic control unit is configured to facilitate the key master to verify that the new session key has been received.

10. The method as recited in claim 9 wherein the information comprises a message authentication code to a message, the message authentication code created using the new session key.

11. The method as recited in claim 3 wherein every electronic control unit has the same session key to securely communicate with each other and no private data is ever transmitted in the clear on the network.

12. A method of updating a session key in a secure vehicle electronic control unit infrastructure, the method comprising the steps of:
at a master requesting a key establishment session and securely sending a message and a message authentication code via an in-vehicle network to a plurality of electronic control units;
at each electronic control unit, generating a random number, the random number configured to verify that the master has a portion of a random number configured to be used to encrypt a session key;
at each electronic control unit, storing the random number configured to verify that the master has the portion of the random number configured to be used to encrypt the session key,
at each electronic control unit, encrypting the random number configured to verify that the master has the portion of the random number configured to be used to encrypt a session key with the portion of the random number configured to be used to encrypt the session key and communicating the encrypted random number configured to verify that the master has the portion of the random number configured to be used to encrypt the session key,
at the master, decrypting the encrypted random number configured to verify that the master has the portion of the random number configured to be used to encrypt a session key number with the portion of the random number configured to be used to encrypt a session key to obtain the random number configured to verify that the master has the portion of the random number configured to be used to encrypt the session key,
at the master, generating a random number configured be a new session key;
at the master, encrypting using symmetric cryptography the new session key with the portion of the random number configured to be used to encrypt the session key from each respective electronic control unit, and encrypting using symmetric cryptography the random number configured to verify that the master has the portion of the random number configured to be used to encrypt a session key from each respective control unit with the new session key and communicating the encryption results to each respective electronic control unit,
at each electronic control unit, decrypting the encryption results and securely storing the session key only if the random number configured to verify that the master has the portion of the random number configured to be used to encrypt a session key matches the random number configured to verify that the master has the portion of the random number configured to be used to encrypt a session key;
at each electronic control unit, communicating to the master if the session key was accepted.
